(19) United States
(12) Patent Application Publication
(10) Pub. No.: US 2026/0308492 A1
(43) Pub. Date: Oct. 8, 2026

(54) METHODS AND COMPOSITIONS FOR A FLAVOR SHIFTING BEVERAGE

(71) Applicant: Star Catcher LLC, Rochester, NY (US)

(72) Inventors: Badri Narayanan, Acampo, CA (US); Elizabeth Brown, Acampo, CA (US)

(73) Assignee: Star Catcher LLC, Rochester, NY (US)

(21) Appl. No.: 19/482,570

(22) PCT Filed: May 6, 2024
(86) PCT No.: PCT/US2024/027923

§ 371 Date: Nov. 7, 2025

Related U.S. Application Data
(60) Provisional application No. 63/465,127, filed on May 9, 2023.

(51) Int. Cl. C12C 1/18

(52) U.S. Cl. CPC C12C 1/18

(57) ABSTRACT

A flavor shifting beverage includes at least three constituent parts: a flavor profile component; a clear malt base component (CMB) or a fermented malt base component (FMB); and a sweetening system component. The flavor shifting beverage is brewed with a flavor profile that presents a gradual sequential transition from a first flavor profile to a second flavor profile. The CMB or FMB may comprise approximately 90 percent per unit volume of the flavor shifting beverage. The sweetener system is combined with the flavor profile component and the CMB/FMB so a consumer may experience the first flavor when they begin consuming the flavor shifting beverage and as the consumer continues to consume the flavor shifting beverage the flavor shifting profile shifts so the consumer experiences a second flavor the flavor shifting beverage.

### CROSS-REFERENCE TO RELATED APPLICATION DATA

This application claims the benefit of U.S. Provisional Patent Application No. 63/465,127 filed on May 9, 2023, the contents of which are hereby incorporated by reference in its entirety.

### FIELD OF TECHNOLOGY

The present disclosure relates generally to methods of manufacturing and compositions for beverages.

### BACKGROUND

Beverages are traditionally flavored by blending various spices and flavor compounds to create a flavor profile. As a consumer consumes the beverage, the strength of the flavor decreases as the consumer's taste receptors develop a taste tolerance to the flavor profile. This can occur because of a coating that develops on the taste receptors from the beverage or as a temporary tolerance to the flavor imparting chemicals.

Previous attempts at overcoming the taste tolerance have included the use of time-release capsules in beverages to create distinct flavors. For example, a capsule may have a first coating encapsulating or including a first flavor and a second coating encapsulating or including a second flavor. Once the capsule's first coating and first flavor has been exhausted, the second coating begins dissolving and releasing the second flavor into the beverage. However, the transition created by these time-release capsules can be abrupt. Additionally, the capsules require costly manufacturing and storage techniques to ensure the capsule is inert during packaging and shipping. Ultimately, implementations known in the art may not reliably and/or cost-efficiently provide an improved flavor profile in beverages leveraging the sensory perceptions of taste.

### SUMMARY

The present disclosure relates generally to implementing/providing a composition for a beverage having a flavor shifting profile, and a method of manufacturing a flavor shifting beverage. The flavor shifting beverage is comprised of three constituent parts: a flavor profile component; a clear malt base component (CMB) or a fermented malt base component (FMB); and a sweetening system component. In an embodiment, a flavor shifting beverage may be brewed with a flavor profile that presents a gradual sequential transition from citrus to cherry flavor profile. The CMB or FMB may comprise approximately 90 percent per unit volume of the flavor shifting beverage. The sweetener system is combined with the flavor profile component and the CMB or FMB to yield the flavor shifting beverage. In an embodiment, the sweetener system is agave and sugar.

When consumed by a consumer, an embodiment of the flavor shifting beverage may taste like citrus initially. As a consumer continues to consume the flavor shifting beverage, it has a flavor shifting profile that causes the flavor shifting beverage to shift to taste like cherry. In this embodiment, the flavor profile component is made of part citrus and part cherry. The citrus and cherry flavor may provide distinct flavors to the consumer. As the consumer continues to consume the flavor shifting beverage, the consumer may taste each of the citrus or cherry taste with the cherry taste strengthening as the consumer continues to consume the flavor shifting beverage.

In a second embodiment, a flavor shifting profile starting with peach and shifting to or ending with ginger may be provided. In a third embodiment, a flavor shifting profile starting with blackberry and shifting to or ending with lime may be provided. In a fourth embodiment, a flavor shifting profile starting with raspberry and shifting to or ending with watermelon may be provided. A person of ordinary skill in the art would understand the flavor principles described herein may be leveraged to form other flavor combinations without departing from the disclosure.

The flavor shifting profile may be created using a mixture of at least two flavorings such as Citrus, Cherry, Peach, Ginger, Blackberry, Lime, Raspberry, and Watermelon; an acid; and a salt. The acid may include at least one of citric acid and malic acid. A salt such as sodium citrate dihydrate may be included to buffer the acid's effect on the pH of the flavor shifting beverage. The salt may prevent the acid from dropping the pH of the flavor shifting beverage below a desired pH range such as 2.5-4.5 pH.

The above summary has outlined, rather broadly, some features and advantages of the present disclosure in order that the detailed description that follows may be better understood. Additional features and advantages of the disclosure will be described below. It should be appreciated by those skilled in the art that this disclosure may be readily utilized as a basis for modifying or designing other structures/processes/steps for carrying out the same purposes of the present disclosure. It should also be realized by those skilled in the art that such equivalent constructions do not depart from the teachings of the disclosure as set forth in the appended claims.

The novel features, which are believed to be characteristic of the disclosure, both as to its organization, method of operation, or resultant product, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

Embodiments of devices, systems, and methods are illustrated in the figures of the accompanying drawings which are meant to be exemplary and non-limiting, in which like references are intended to refer to like or corresponding parts, and in which:

FIG. 1 illustrates a human palate depicting taste receptors on a tongue.

FIG. 2 illustrates a block diagram of components for a flavor shifting beverage according to the disclosure.

FIG. 3 illustrates a flow diagram of a method for manufacturing a flavor shifting beverage in an embodiment of the disclosure.

FIG. 4 illustrates a flow diagram for a consumer's consumption experience of an embodiment of the flavor shifting beverage according to the disclosure.

### DETAILED DESCRIPTION

The detailed description of aspects of the present disclosure set forth herein makes reference to the accompanying drawings, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, references to a singular embodiment may include plural embodiments, and references to more than one component may include a singular embodiment.

A human tongue contains numerous taste receptors allowing for stimulation of taste centers associated with, for example, umami, bitter, sour, sweet, and salty. As a consumer drinks a beverage, the natural flavor chemicals such as peach or ginger impact the taste receptors on the tongue and trigger a taste center in the brain of the consumer. As a result, a beverage may be interpreted as being sweet or spicy. However, as the consumer continues to drink the beverage, the taste receptors may send a weakened signal to the taste centers thereby numbing the flavor or diminishing the perception of the flavor by the consumer. This can occur as a result of numerous natural processes, including developing a temporary taste tolerance to the flavor chemicals. Additionally, physiological developments, e.g., a coating on the taste receptors, may develop from interactions with the beverage weakening the ability of the flavor chemicals to reach the taste receptors.

A person of ordinary skill in the art should understand that a fruity or spicy flavor is not just one flavor. Rather these flavors comprise numerous individual flavor notes caused by individual flavor compounds at varying concentrations. The resulting aggregation or symphony of flavor(s) provides the overall characteristic aroma/taste of a flavor such as citrus, cherry, peach, ginger, raspberry, blackberry, lime, or watermelon.

A flavor may be fractionalized into the individual notes and altered to create different flavor profiles. Manipulation of these individual notes as described herein may create a flavor shifting profile. The flavor shifting profile, according to the disclosure, may leverage the individual notes to create a gradient shift in a flavor experience as a flavor shifting beverage is consumed. The flavor shifting profile may leverage the individual notes to create multiple distinct flavors which shift between each other as experienced or tasted on the palate. For example, according to the disclosure, a consumer may taste a first flavor then a second flavor in a first sip. Then the second flavor before the first flavor in a second sip. The second flavor in the flavor shifting profile may grow in strength as the flavor shifting beverage is consumed.

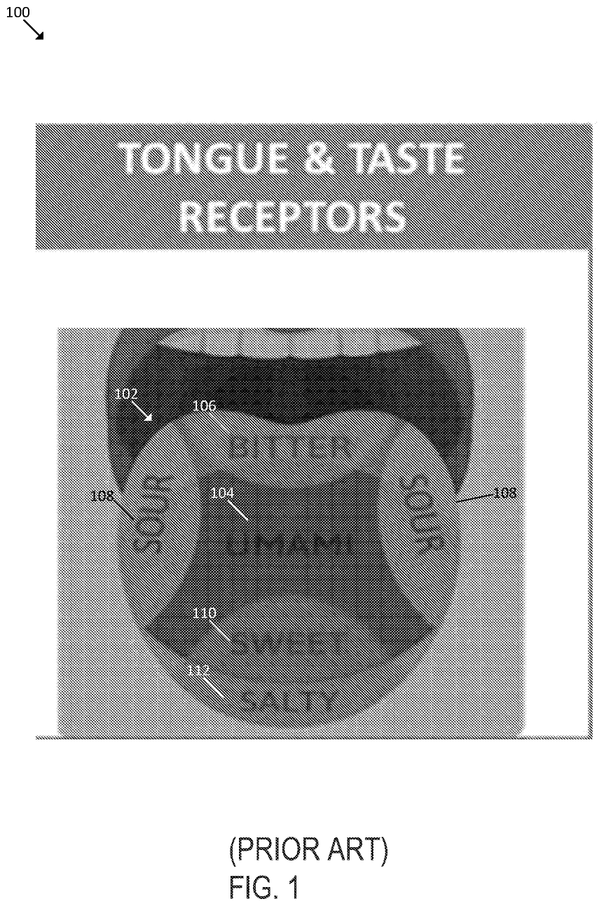

FIG. 1 illustrates a human palate 100 depicting sensitivities of taste receptors on a human tongue 102. Although some research indicates taste receptors for all tastes exist all over the tongue, some of the areas of the tongue may be more sensitive to particular tastes. The five major taste receptor sensitivities are umami 104, bitter 106, sour 108, sweet 110, and salty 112. As a beverage is consumed, the flavor notes of the beverage interact with the taste receptors located on the human tongue 102. Each taste receptor sends a signal to the taste center in the brain indicating a flavor profile and provoking an interpretation of the beverage flavor. The individual flavor notes interact across the tongue to provoke signals sent to the taste center matching the flavor profile of the beverage. A sweet beverage may provoke a strong signal from the sweet taste receptors 110 and a weak signal from the sour taste receptors 108. As a result, the taste center in the brain may provide an interpretation that the beverage is sweet to the consumer. Similarly, a sour beverage may provoke a strong signal from the sour taste receptors 108 and a weak signal from the sweet taste receptor 110. As a result, the taste center in the brain may provide an interpretation to the consumer that the beverage is sour.

Single flavors such as citrus, cherry, raspberry, watermelon, blackberry, lime, peach or ginger each has its own individual flavor profile including multiple individual flavor notes. Each flavor thus interacts across the human tongue 102 and taste receptors to instill an impression on the consumer that the flavor is associated with a known taste. For example, a peach drink may remind a consumer of eating a peach.

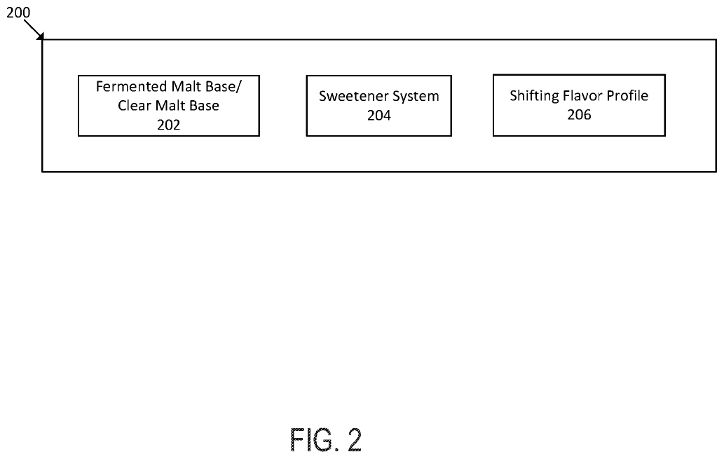

FIG. 2 illustrates a block diagram of components for a flavor shifting beverage 200, that when consumed by a consumer may initially taste like a first flavor component and subsequently in the consumption may taste like a second flavor component, according to the disclosure. An embodiment of the flavor shifting beverage 200 may include a fermented malt base or a clear malt base 202, a sweetener system 204, and a flavor shifting profile 206. The flavor shifting beverage 200 may have an Alcohol By Volume (ABV) specification of approximately 6±0.3%.

In an illustrative embodiment the flavor shifting profile 206 may be e.g., Citrus Cherry. As a consumer begins consuming the flavor shifting beverage 200, the flavor notes of the flavor shifting beverage 200 may interact with the taste receptors on the consumer's tongue. In the illustrative embodiment, the consumer may initially taste a fruity fresh citrus experience or aroma. As the consumer continues to taste the flavor shifting beverage 200, the flavor profile shifts to an aromatic cherry flavor taste experience. In subsequent tastes of the illustrative embodiment the consumer may taste an initial taste of the aromatic cherry flavor towards the beginning of the flavor shifting beverage 200 which strengthens as the consumer consumes the flavor shifting beverage 200 The fermented malt base or clear malt base 202 may include a mixture of water, a fermentable sugar (e.g., malt syrup, sucrose, dextrose, and/or high fructose corn syrup), hops, and a yeast. An embodiment of the fermented malt base or clear malt base 202 may include: 0 -90 percent volume to volume of water, 0-35 percent volume to volume of malt syrup, 0-35 percent volume to volume of sucrose, 0-35 percent volume to volume of dextrose, 0-35 percent volume to volume of lactose, 0-35 percent volume to volume of high fructose corn syrup (HFCS), 0 -10 percent volume to volume of hop extract, and 0-5 percent weight to volume of yeast. The fermented malt base or clear malt base 202 may be similar across embodiments of the flavor shifting beverage 200.

The sweetener system 204 may include a mixture of water and a sweetener such as a sugar. An embodiment of the sweetener system 204 may include: 0 -90 percent volume to volume of water, 0-12 percent volume to volume of agave, and 0-12 percent volume to volume of sucrose. The sweetener system 204 may be the same across embodiments within the ranges provided, or it may be adjusted, e.g., to taste, or pH, or ABV, for each embodiment of the flavor shifting beverage 200 such that the relative volume to volume percentage of the sweetener system 204 components is specific to each embodiment (e.g., it may be desirable to have some beverages sweeter than others).

The shifting beverage profile 206 may include at least two flavorings (a first flavor profile and a second flavor profile), a color dye, an acid, and a salt. For example, the Citrus Cherry embodiment of the shifting beverage profile 206 may include: 0-0.7 percent volume to volume of Citrus SIA000580001 available from Sensient Flavors and Extracts Group located in Hoffman Estates, Illinois 60169, 0-0.5 percent volume to volume of Cherry 8.62467 available from Doehler North America located in Cartersville, GA 30120, 0-2.5 percent volume to volume of Citric Acid Blender 180 Proof available from Greenfield Global, located in Brampton, ON, CA, 0-0.15 percent volume to volume of Natural Flavor 567051 T available from Firmenich SA located in Geneva, Switzerland. By way of further example, the shifting beverage profile 206 in this embodiment may also include 0-1 percent volume to volume of red liquid coloring. To control pH, the shifting beverage profile 206 in this embodiment may also include 0-5 percent volume to volume of Citric Acid, 0-5 percent volume to volume of Malic Acid, and 0-5 percent volume to volume of Sodium Citrate Dihydrate.

The flavor shifting beverage 200 may trigger the different taste receptors on the consumer's tongue to provide different flavor notes throughout the consumption of the flavor shifting beverage 200. The consumer's palate, as discussed and illustrated with respect to FIG. 1, may enable a tasting experience such as tasting sweet and salty flavors upfront and shifting to a bitter/pungent (such as a spice like ginger or chili) taste towards the end of the tasting experience. Bitter/pungent compounds may be heavier and may create an aftertaste lingering on the tongue. By way of example, embodiments of the flavor shifting beverage 200 may include flavor combinations of Citrus Cherry, Peach Ginger, Blackberry Lime, or Raspberry Watermelon. A consumer may taste the first flavor component of the flavor shifting profile, e.g., citrus, peach, blackberry, or raspberry flavor of the respective embodiments, when they begin consuming the flavor shifting beverage 200. As the consumer continues consuming the flavor may shift and strengthen the second flavor component of the flavor shifting profile, e.g., cherry, ginger, watermelon, lime, or raspberry in the respective embodiments.

The illustrative examples of Citrus Cherry, Peach Ginger, Blackberry Lime, and Raspberry Watermelon, embodiments leverage the flavor principles described above to cause a citrus aroma, fruity peach, blackberry or raspberry ketone as an upfront fruity flavor when the consumer begins consuming the flavor shifting beverage 200. The second illustrative flavor component cherry (aromatic), ginger (spice), lime or watermelon (rind) flavors build up over time to create a shift in the flavor of the flavor shifting beverage 200 over the course of the experience. The flavor notes used create a distinct perception of both flavors, and may include a gradient of overlap during the shift from the first flavor to the second flavor. As a result, the flavor shifting beverage 200 may provide a gradual change in the flavor profile across a gradient instead of as an abrupt shift in taste. A person of ordinary skill in the art should appreciate that the foregoing principles may be leveraged to create abrupt shifts in the flavor shifting profile of a flavor shifting beverage 200 if desired and that such shifts are within the scope of the present disclosure.

According to the disclosure, an illustrative embodiment of the flavor shifting beverage 200 of Citrus Cherry changes which taste receptors are targeted by the flavor notes resulting in a shift in the consumer's flavor experience. As a consumer continues to consume the flavor shifting beverage 200, the sensation created by the citrus flavor on the sweet taste receptors may be overcome by the aromatic cherry flavor. As the heavier aromatic cherry flavor accumulates and lingers on the taste receptors, the flavor shifting profile 206 shifts from citrus towards cherry. For example, the flavor shifting beverage 200 may start with stronger notes of sweetness due to the citrus flavor and shift to the aromatic flavor such as cherry as the aromatic compounds accumulate. The Citrus Cherry embodiment may leverage the flavor shifting profile 206 in each sip to provide an initial taste of the first flavor component citrus followed by a taste of a second flavor component cherry. A subsequent sip may shift to provide an initial taste of the second flavor component followed by a taste of the first flavor component.

The Citrus Cherry flavor shifting beverage may include citrus flavors containing water soluble fresh aroma compounds and oils that are richer in deeper intense aromatics. The fruity fresh citrus aroma may be paired with an aromatic cherry (e.g., benzaldehyde, linalool & eugenol). The fresh citrus upfront flavor has minimal overlap with the aromatic benzaldehyde (characteristic cherry flavor). Thus the paired flavors enable perception of the two flavors individually as disclosed herein. Consuming the flavor shifting beverage may be a continuous process of taking sip after sip. Hence the order of the paired flavors may shift resulting in some perceiving cherry followed by citrus or vice versa. The strength of a flavor shifting profile may be experienced differently between individuals based on their specific palate sensitivities. The flavor shifting profile may leverage the principles disclosed herein to provide the flavor shift experience as described across a wide spectrum of individual tastes and palates.

A Peach Ginger embodiment of the flavor shifting beverage 200 may taste like peach at the first sip and like ginger after a shift from the first flavor to the second flavor of the flavor shifting beverage. The Peach Ginger flavor shifting beverage leverages the distinction between the fresh fruity peach flavor and the spicy ginger flavor to have minimal overlap in taste experience. As the Peach Ginger flavor shifting beverage is consumed, the ginger flavor may gradually build up over time on the bitter/pungent receptors on the tongue. An illustrative embodiment of the Peach Ginger flavor shifting beverage may include low dosages of ginger compared to peach to enable gradual build-up of the ginger flavor intensity during consuming of the flavor shifting beverage.

An illustrative embodiment of the Peach Ginger shifting beverage profile 206 may include: 0-1 percent volume to volume of, e.g., Peach JG-480-758-5 available from Givaudan SA located in Zurich, Switzerland, 0-1 percent volume to volume of Ginger 8.71129 available from Doehler North America located in Cartersville, GA 30120, 0-0.2 percent volume to volume of Ginger (spice) SIA000580006 from Sensient Flavors and Extracts Group located in Hoffman Estates, Illinois 60169, 0-0.15 percent volume to volume of Natural Flavor 567051 T available from Firmenich SA located in Geneva, Switzerland, 0-2.5 percent volume to volume of Citric Acid Blender, 0-1 percent volume to volume of peach liquid coloring. To control pH, the shifting beverage profile 206 in this embodiment may include 0-5 percent volume to volume of Citric Acid, 0-5 percent volume to volume of Malic Acid, and 0-5 percent volume to volume of Sodium Citrate Dihydrate.

A Blackberry Lime embodiment of the flavor shifting beverage 200 may taste like blackberry at the first sip and like lime after a shift from the first flavor component to the second flavor component of the flavor shifting beverage. The Blackberry Lime flavor shifting beverage may include a blackberry ketone as a characteristic blackberry flavor and a rindy lime finish to deliver a consumer with a clear perception of both flavors as part of the flavor shifting profile. An embodiment of a Blackberry Lime flavor shifting profile may include shifting between the two flavors with each sip. In the embodiment according to the disclosure, the blackberry and lime flavors include few overlapping common flavor compounds allowing for distinct flavor shifting from one sip to the next. The Blackberry Lime flavor shifting beverage may leverage the blackberry ketone to provide a stronger blackberry flavor at the beginning and then shift to a lime rind finish.

An illustrative embodiment of the Blackberry Lime shifting beverage profile 206 may include, e.g., 0-0.5 percent volume to volume of Blackberry MX-848-796-4 available from Givaudan SA located in Zurich, Switzerland, 0-0.5 percent volume to volume of Lime SN2000038408 available from Sensient Flavors and Extracts Group located in Hoffman Estates, Illinois 60169, 0-2 percent volume to volume of Citric Acid Blender, and 0-1 percent volume to volume of Black carrot blue shade. To control pH the shifting beverage profile 206 in this embodiment may also include 0-5 percent volume to volume of Citric Acid, 0-5 percent volume to volume of Malic Acid, and 0-5 percent volume to volume of Sodium Citrate Dihydrate.

A Raspberry Watermelon embodiment of the flavor shifting beverage 200 may taste like raspberry at the first sip and like watermelon after a shift from the first flavor to the second flavor of the flavor shifting beverage. The Raspberry Watermelon flavor shifting beverage may include a raspberry ketone as a characteristic raspberry flavor and a rindy watermelon finish to deliver a consumer with a clear perception of both flavors as part of the flavor shifting profile. An embodiment of a Raspberry Watermelon flavor shifting profile may include shifting between the two flavors with each sip. The raspberry and watermelon flavors include few overlapping common flavor compounds allowing for distinct flavor shifting from one sip to the next. The Raspberry Watermelon flavor shifting beverage may leverage the raspberry ketone to provide a stronger raspberry flavor at the beginning and then shift to a watermelon rind finish.

An illustrative embodiment of the Raspberry Watermelon shifting beverage profile 206 may include, e.g.,: 0-0.5 percent volume to volume of Raspberry 634883 available from Givaudan SA located in Zurich, Switzerland, 0-0.5 percent volume to volume of Watermelon 6.08271 available from Doehler North America located in Cartersville, GA 30120, 0-0.5 percent volume to volume of Watermelon SIA000580003 available from Sensient Flavors and Extracts Group located in Hoffman Estates, Illinois 60169, 0-2 percent volume to volume of Citric Acid Blender, and 0-1 percent volume to volume of Pink Liquid Color. To control pH the shifting beverage profile 206 in this embodiment may also include 0-5 percent volume to volume of Citric Acid, 0-5 percent volume to volume of Malic Acid, and 0-5 percent volume to volume of Sodium Citrate Dihydrate.

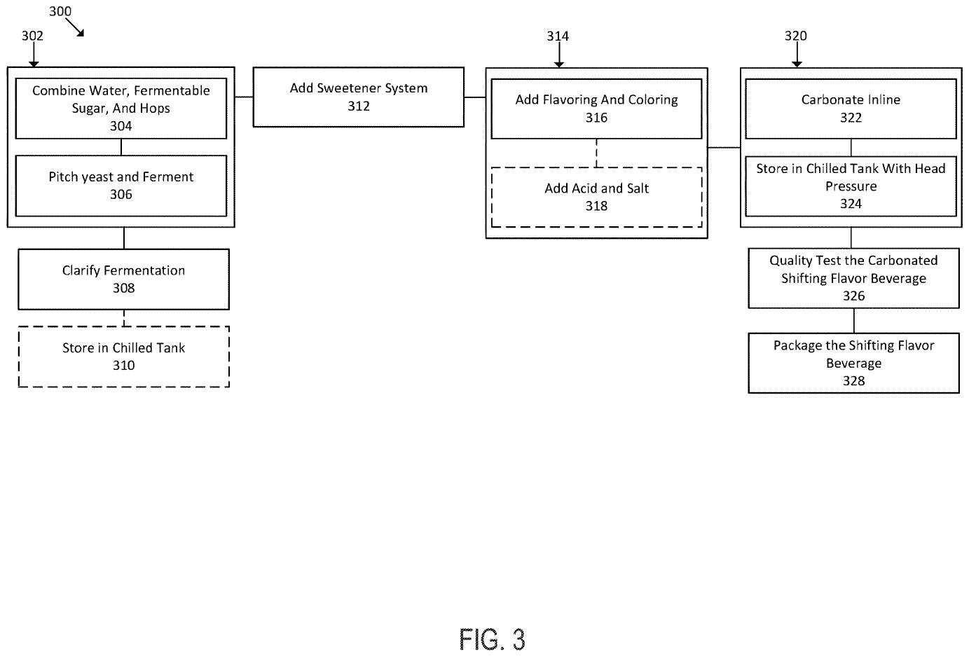

FIG. 3 illustrates a flow diagram of a method for manufacturing 300 a flavor shifting beverage in an embodiment of the disclosure. A fermented malt base or a clear malt base may be brewed 302 by combining 304 with water, at least one fermentable sugar, and hops. Examples of a fermentable sugar include malt syrup, sucrose, dextrose, and high fructose corn syrup (HFCS). The mixture of water, fermentable sugar, and hops may be mixed to achieve an original gravity of approximately 20-30 degrees Brix (° Bx). Degrees Brix, as known in the art, is a measure of the dissolved solids in a liquid. One (1) degree Brix is 1 gram of sucrose in 100 grams of solution.

Yeast may be pitched or added to the mixture and allowed to ferment 306. The resulting fermentation may be clarified 308 such as by separating out any sedimentation using a centrifuge. A filter or carbon may be used in addition or in place of the centrifuge, until a desired clarity is reached. The clarified mixture may be stored 310 in a chilled tank.

A sweetener system may be added 312 to the mixture. The sweetener system may be a mixture of water and at least one sweetener such as agave or sucrose. A flavor shifting profile may be created 314 by adding 316 flavor enhancers, flavoring, and coloring. An acid and a salt may be added 318 to the flavor shifting profile to achieve a desired pH. The salt may act as a buffer to stabilize the pH and prevent it from going outside of a desired pH range. The pH in an embodiment may be 2.5-4.5. The mixture, sweetener system, and flavor shifting profile may be mixed to form a solution and create 320 a flavor shifting beverage.

The flavor shifting beverage may be carbonated 322 inline. The carbonation process may include injecting carbonate oxalate into the flavor shifting beverage. A water source which has had all air removed may be utilized for carbonating 322 the flavor shifting beverage. The flavor shifting beverage may be recirculated until a desired pressure is achieved. An embodiment of the flavor shifting beverage may be carbonated 322 to a pressure of approximately 2-3 volumes or 2-3 fluid ounces of carbonate oxalate dissolved into the flavor shifting beverage. The carbonated flavor shifting beverage may be stored 324 in a chilled tank with a head pressure to prevent loss of carbonation. As a person of ordinary skill in the art should appreciate, the total volume of carbonation that can be retained by a liquid is dependent on the pressure and temperature of the liquid. Storage of a liquid under pressure and at a predetermined temperature can prevent evaporative loss of carbonation from the liquid.

The carbonated flavor shifting beverage may undergo quality testing 326. The carbonated flavor shifting beverage may be tested for clarity, carbonation, pH, and ABV, among other things. If the ABV of the carbonated flavor shifting beverage is outside of a desired range, such as approximately 6±0.3% ABV, water may be added to reduce the ABV or a fermented malt base or clear malt base may be added to increase the ABV.

The carbonated flavor shifting beverage may be packaged 328 for shipping and distribution. Packaging 328 may include sending the carbonated flavor shifting beverage to a coupler pressure filling head to seam and seal the carbonated flavor shifting beverage in a container such as a can. The coupler pressure filling head may insert a pipe into the interior of the container and form a vacuum within the container. The carbonated flavor shifting beverage may be dispensed into the container under pressure to fill the container. The coupler pressure filling head may seam and seal the container to enclose the carbonated flavor shifting beverage within the container while containing the carbonation pressure and preventing splashing of the carbonated flavor shifting beverage during packaging 328.

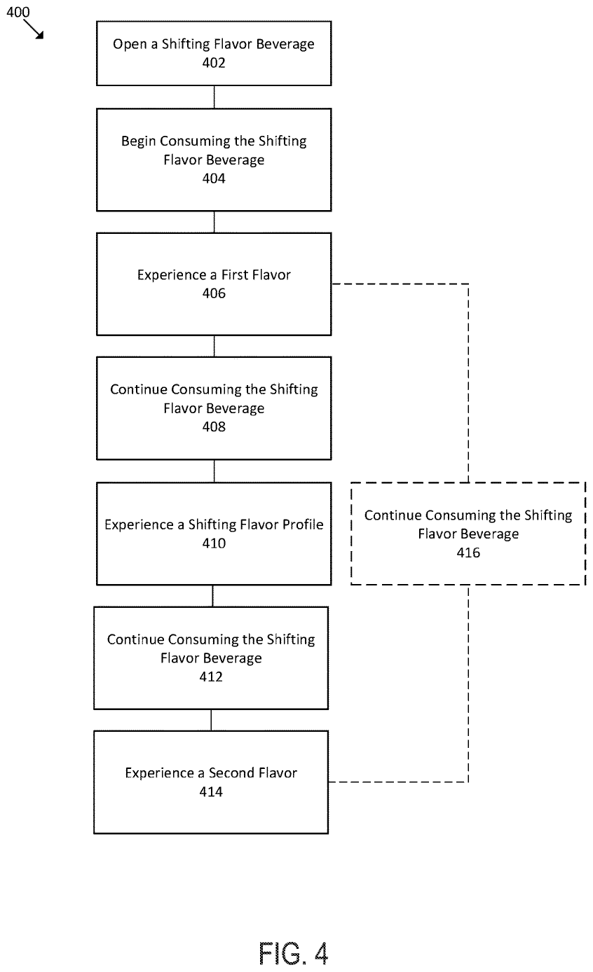

FIG. 4 illustrates a flow diagram for a consumer's consuming experience 400 of an embodiment of the flavor shifting beverage. A consumer opens 402 an embodiment of the flavor shifting beverage and begins consuming 404 the flavor shifting beverage. The consumer's taste receptors send taste signals to the taste center in the consumer's brain for experiencing 406 a first flavor. As the consumer continues consuming 408 the flavor shifting beverage, the consumer experiences 410 the flavor shifting profile. Continued consumption 412 of the flavor shifting beverage allows the flavor shifting profile to complete a flavor transition and provides the experience 414 of a second flavor. A person of ordinary skill in the art should appreciate that additional flavors may be provided within the scope of this disclosure using the system and methods described.

An illustrative embodiment may shift between experiencing a first flavor or a second flavor first with each sip. For example, a first sip of the flavor shifting beverage may lead with the first flavor before the consumer tastes the second flavor. A second sip of the flavor shifting beverage may lead with the second flavor before the consumer tastes the first flavor. A third sip of the flavor shifting beverage may lead with either the first flavor or the second flavor before the consumer tastes the other flavor. As the consumer consumes the flavor shifting beverage, the second flavor may grow stronger in taste, especially if the second flavor is a spicy, pungent flavor that results in saturation of the palate. Generally, the flavor shifting beverage may utilize the sensory perception of taste to provide at least two distinct flavors throughout consumption of the flavor shifting beverage.

A second illustrative embodiment may shift between the first flavor and the second flavor wherein the second flavor is a spicy, pungent flavor that results in saturation of the palate, e.g., ginger. As a consumer begins consuming 404 a flavor shifting beverage, the first flavor may be experienced 406 with a first sip. A second sip 408 or 412 of the flavor shifting beverage may provide the experience 410 of the flavor shifting profile to give the consumer the experience 414 of the second flavor. Continued consumption 416 of the flavor shifting beverage in a further sip may shift the consumer's flavor experience 406 to the first flavor. As the consumer continues consuming 408, 412, 416 the flavor shifting beverage, the consumer's experience 410 of the flavor shifting profile may shift between the experience 406 of the first flavor and the experience 414 of the second flavor throughout the process. As the flavor shifting beverage continues to be consumed 408, 412, 416, the consumer may experience a gradual shift towards experiencing 414 a stronger second flavor. For example, an aromatic citrus flavor (e.g., a first flavor) may be strong at the beginning 404 of the flavor shifting beverage but less prominent towards the end of the flavor shifting beverage as a ginger flavor (e.g., as a second flavor) accumulates on the consumer's tongue. A second flavor that results in saturation of the palate may result in a flavor shifting beverage wherein the second flavor predominates until the beverage is fully consumed.

Benefits, other advantages, and solutions to problems have been described herein with regard to specific embodiments. However, the benefits, advantages, solutions to problems, and elements that may cause any benefit, advantage, or solution to occur or become more pronounced are not to be construed as critical, required, or essential features or elements of the disclosure. It should be appreciated that in the appended claims, reference to an element in the singular is not intended to mean “one and only one” unless explicitly so stated, but rather “one or more.”

Embodiments of the present disclosure are described herein with reference to the accompanying drawings. However, the present disclosure should not be construed as limited to the embodiments set forth herein. Rather, these embodiments are provided so that this disclosure will be thorough and complete, and will fully convey the scope of the present disclosure to those skilled in the art. As used herein, the singular forms “a,” “an,” and “the” are intended to include the plural forms as well, unless the context clearly indicates otherwise. It will be further understood that the terms “comprises,” “comprising,” “having,” “includes,” “including,” and/or variations thereof, when used herein, specify the presence of stated features, steps, operations, elements, and/or components, but do not preclude the presence or addition of one or more other features, steps, operations, elements, components, and/or groups thereof. Where ranges are given, endpoints are included. Furthermore, unless otherwise indicated or otherwise evident from the context and understanding of one of ordinary skill in the art, values that are expressed as ranges can assume any specific value or sub-range within the stated ranges in different embodiments of the invention, to the tenth of the unit of the lower limit of the range, unless the context clearly dictates otherwise.

Although illustrative embodiments of the present disclosure have been described herein with reference to the accompanying drawings, it is to be understood that the present disclosure is not limited to those precise embodiments, and that various other changes and modifications may be made by one skilled in the art without departing from the scope or spirit of the disclosure.

What is claimed is:

1. A beverage comprising:
a fermented malt base;
a sweetener system added to the fermented malt base; and
at least one flavor profile added to the fermented malt base and the sweetener system, the at least one flavor profile including a first flavor component and a second flavor component, added to the fermented malt base and the sweetener system to form a flavor shifting beverage.

2. The beverage of claim 1 wherein the fermented malt base (FMB) is a clear malt base (CMB).

3. The beverage of claim 2 wherein the CMB or FMB comprise approximately 90 percent per unit volume of the flavor shifting beverage.

4. The beverage of claim 1 wherein the flavor shifting beverage is configured to provide a shift from the first flavor component to the second flavor component during consumption of the flavor shifting beverage.

5. The beverage of claim 1 wherein the sweetener system is at least one of agave and sugar.

6. The beverage of claim 1 wherein the at least one flavor profile is configured using flavorings of Citrus, Cherry, Peach, Ginger, Raspberry, Blackberry, Lime, and Watermelon.

7. The beverage of claim 1 wherein the at least one flavor profile is configured using a first flavor component of one of Citrus, Peach, Blackberry, and Raspberry, and a second flavor component of one of Cherry, Ginger, Lime, and Watermelon.

8. The beverage of claim 1 wherein the flavor shifting beverage further comprises at least one of an acid and a salt to control pH.

9. The beverage of claim 8 wherein the acid is at least one of citric acid and malic acid.

10. The beverage of claim 8 wherein the salt is sodium citrate dihydrate.

11. The beverage of claim 8 wherein the pH of the flavor shifting beverage is in a pH range of 2.5-4.5 pH.

12. A method of making a beverage, the method comprising the steps of:
providing at least one of a fermented malt base and a clear malt base;
adding a sweetener system, the sweetener system including water and at least one of agave and sucrose;
adding a flavor shifting profile having a first flavor component and a second flavor component and the flavor shifting profile created by adding at least one of flavor enhancers, coloring, and an acid and a salt to achieve a desired pH;
the at least one of a fermented malt base and a clear malt base, sweetener system, and flavor shifting profile mixed to form a flavor shifting beverage.

13. The method of making a beverage of claim 12, wherein the step of providing at least one of a fermented malt base and a clear malt base includes combining water with at least one fermentable sugar, and hops, and adding yeast to allow fermentation.

14. The method of making a beverage of claim 13, wherein in the step of providing at least one of a fermented malt base and a clear malt base the fermentable sugar includes at least one of malt syrup, sucrose, dextrose, and high fructose corn syrup (HFCS).

15. The method of making a beverage of claim 13, wherein the step of combining water, fermentable sugar, and hops and yeast achieves a resulting fermentation with an original gravity of approximately 20-30 degrees Brix (° Bx).

16. The method of making a beverage of claim 12 wherein the flavor shifting profile is configured using flavorings of Citrus, Cherry, Peach, Ginger, Raspberry, Blackberry, Lime, and Watermelon.

17. The method of making a beverage of claim 13 wherein the flavor shifting profile is configured using as the first flavor component one of Citrus, Peach, Blackberry, and Raspberry, and using as the second flavor component one of Cherry, Ginger, Lime, and Watermelon.

18. The method of making a beverage of claim 15, wherein the resulting fermentation is clarified by separating out any sedimentation using at least one of a centrifuge and a filter, until a desired clarity is reached.

19. The method of making a beverage of claim 12, wherein the flavor shifting beverage is carbonated inline by injecting carbonate oxalate into the flavor shifting beverage.

20. The method of making a beverage of claim 19, wherein the flavor shifting beverage is carbonated to a pressure using approximately 2-3 fluid ounces of carbonate oxalate dissolved into the flavor shifting beverage.
